(19) United States
(12) Patent Application Publication
(10) Pub. No.: US 2008/0147235 A1
(43) Pub. Date: Jun. 19, 2008

(54) SURGICAL INSTRUMENT

(76) Inventors: Jean-Albert Despres, Souesmes (FR); Martine Normandin, Souesmes (FR)

Correspondence Address: LEYDIG VOIT & MAYER, LTD, 700 THIRTEENTH ST. NW, SUITE 300, WASHINGTON, DC, 20005-3960, US

(21) Appl. No.: 11/956,371

(22) Filed: Dec. 14, 2007

(30) Foreign Application Priority Data
Dec. 15, 2006 (FR) 0655570

(51) Int. Cl. G06F 7/00

(52) U.S. Cl. 700/225

(57) ABSTRACT

The invention concerns a surgical instrument defined by shape and function. The instrument includes and identification part for the identification of the instrument, connected to the external surface of the instrument. The invention can be used for the automated sorting of surgical instruments.

### FIELD OF THE INVENTION

The invention concerns an instrument such as a surgical instrument of a predetermined type, defined by its shape and its function among a plurality of instruments of different types.

### BACKGROUND

Known instruments of this type can be recognized or identified by individuals before they handle them based on their visual external appearance, but they are not suitable for automated sorting.

### SUMMARY OF THE INVENTION

The purpose of the invention is to propose instruments whose type can be recognized automatically.

To achieve this purpose, an instrument according to the invention is characterized in that it comprises a part for the identification of the instrument, connected to the external surface of the instrument.

According to a characteristic of the invention, the instrument is characterized in that the connected part contains an element allowing the identification of the instrument.

According to another characteristic of the invention, the instrument is characterized in that the identification information resides in the shape of the identification element.

According to yet another characteristic of the invention, the instrument is characterized in that the identification element is made of a relatively X-ray opaque material, while the above-mentioned part, and if applicable the instrument are made of a relatively X-ray transparent material.

According to yet another characteristic of the invention, the instrument is characterized in that the identification element has a flat shape comprising cutouts of specific shapes constituting the identification information.

According to yet another characteristic of the invention, the invention is characterized in that the identification element is a body of revolution.

### BRIEF DESCRIPTION OF DRAWING FIGURES

The invention will be better understood, and other purposes, characteristics, details and advantages of the invention will become clearer in the explanatory description which follows and which is made in reference to the attached schematic drawings, given only as examples illustrating several embodiments of the invention, and in which:

FIG. 1 is a schematic perspective view of an installation for the recognition of surgical instruments according to the invention, each provided with an identification part, according to the invention,

FIGS. 2 and 3 are schematic views of a first surgical instrument type according to the invention, representing two embodiment versions of the connected identification part;

FIGS. 4A and 4B are top and side views, respectively, of a second surgical instrument type provided with a connected identification part according to the invention;

FIG. 5 is a schematic view of a third surgical instrument type provided with a connected identification part according to the invention;

FIGS. 6-8 show three versions of different connected identification parts connected to a fourth surgical instrument type.

### DETAILED DESCRIPTION

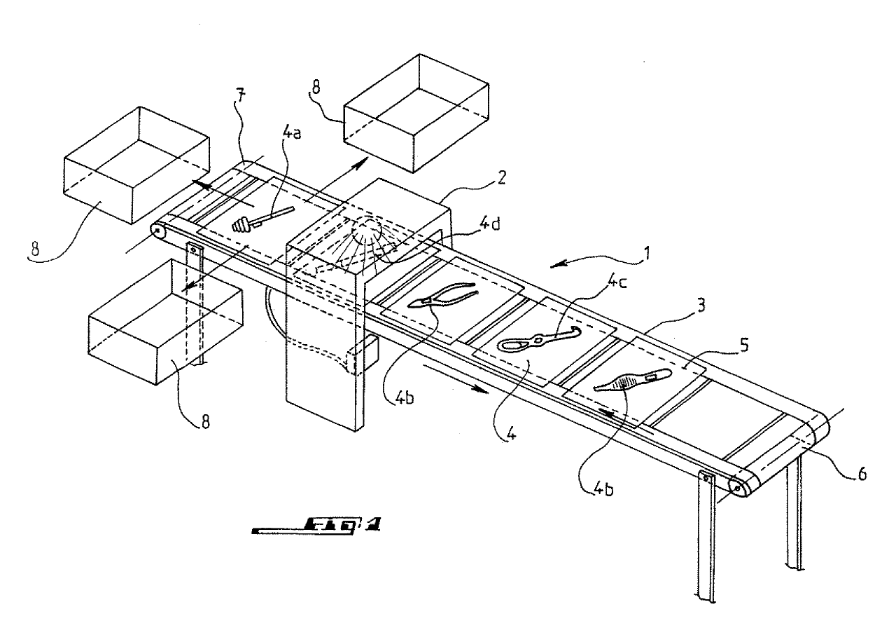

The invention concerns surgical instruments having different functions and shapes, each provided with an identity code to allow automatic recognition, for example by a recognition installation as represented in FIG. 1.

This installation, designated by general reference numeral 1, essentially comprises a station 2 for the recognition of the surgical instruments, provided with an X-ray reader in the form of a gate, and a conveyor belt 3 intended to advance surgical instruments 4 of different type, and which are to be identified by the recognition station 2.

In the example represented, the surgical instruments 4 are each placed on a support 5 and moved from the inlet end 6 of the conveyor 3 to the other end 7, or after passage under the reading gate 2 they are distributed by any known appropriate means into different containers 8 according to predetermined criteria.

FIG. 1 shows five surgical instruments types 4, which are given as examples and described below in greater detail in reference to FIGS. 2-8.
The four instrument types bear the reference numerals 4 a to 4d, respectively.

The special feature of the surgical instruments 4 according to the invention resides in the fact that each is provided with a connected part 10, which contains a sealed element 11 that carries an identification code of the instrument.

The elements 11 are made of a relatively X-ray opaque material, while the envelope part 12 and the instruments are manufactured from a relatively X-ray transparent material or are at least as opaque to this radiation as the identification element 11.

It is thanks to this difference in opacity that the X-ray reader 2 can recognize the shape of the identification elements of the instruments passing through this reader, these shapes constituting the information which identifies the instrument to which it is connected.

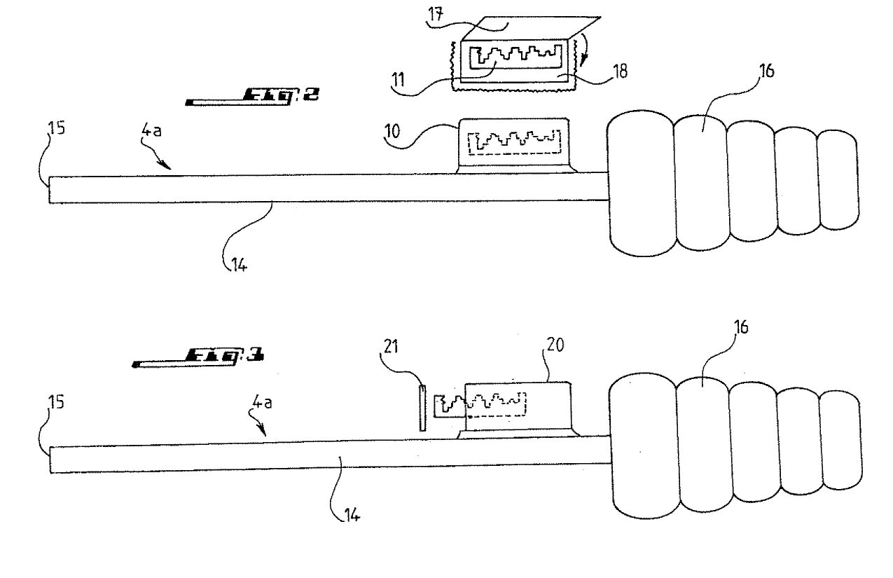

FIGS. 2 and 3 show an instrument of a first type, designated by reference numeral 4a, and comprises a cannula or an aspiration tube 14 whose one end, noted 15, is open while the other end carries an aspirator bulb 16 of rubber, for example.

The identification part 10 is connected in any appropriate way to the external face of the tube 14 below the bulb 16, by welding for example.

The part 10 comprises, as can be seen in FIG. 2, an external envelope 12 formed by two flaps 17,18 that can pivot about a bending line 18 to be able to enclose the identification element 11 in the folded state of one on the other.

The latter is formed from a small plate in which specially shaped cutouts have been made and which constitute the information that allows the identification of the instrument.

Given that the information part 10 is fixed to the external face of the instrument at an appropriate place, it does not interfere with the handling of the instrument. The identification element 12 can then comprise not only the information proper for identifying the instrument, but if applicable supplemental information that is useful when handling and using the instrument.

For example, the identification element could comprise information pertaining to the number of times the instrument is used, and to precautions for handling and use.

Compared to FIG. 2, FIG. 3 shows that the envelope 12 could also be made of a relatively flat parallelepiped casing, noted 20, in which the identification element 11 is inserted laterally after the fixation of the casing to the tube. After insertion, the casing is closed by a closing device 21.

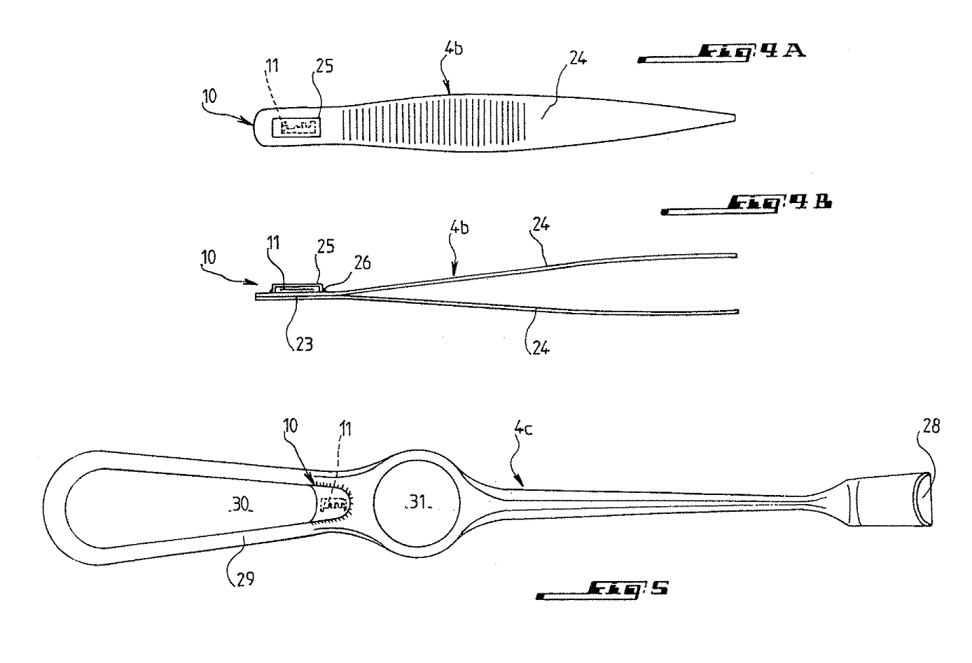

FIGS. 4A and 4B show a second surgical instrument type, designated by reference numeral 4b, namely forceps.

These forceps can be recognized as such, thanks to the fixation of the identification part 10 to the area 23 of junction of the two branches 24 of the forceps.

The part presents the shape of a flat quasi-parallelepipedal casing 25, fixed flat to the area 23, by welding for example, after the insertion of the identification element 11. To ensure a leakproof fixation, the welding bead 26 extends completely around the casing. Instead of having a closed casing, the casing could also be tray shaped, and placed so that it rests on the area 23 by its free external edges.

FIG. 5 illustrates a third surgical instrument type, designated by reference numeral 4c, namely forceps, provided with a curved end area 28, and another end 29 is configured as an operational part provided with a recess 30.

In this case, the identification casing 10 is placed in the end of the recess 20 close to the center 31 of the instrument, which is in an area where this part, fixed by welding for example, does not interfere with the use of the instrument.

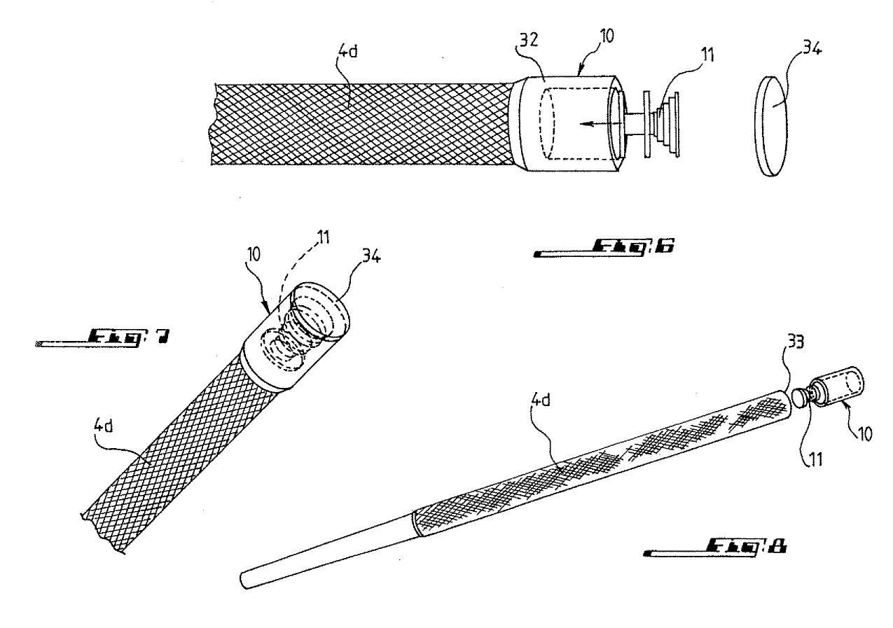

FIGS. 6-8 show yet another surgical instrument type, designated by reference numeral 4d, namely a gouge to which is connected a cylindrical identification part 10 fixed on the free handling end 32.

In the case of FIGS. 6 and 7, the tubular body 32 is connected at the end 33 of the gouge. It is hollow and intended to receive the identification element 11, then in the shape of a body of revolution so that the information constituted by its shape is legible in all the angular positions of the instrument. After the insertion of the element 10, the tubular body 28 is closed by a cover 34.

In the case of FIG. 8, the identification element constitutes the axial extension of the cylindrical body 32, and it is introduced into the now hollow end 33 of the gouge, the fixation of the body 32 made leakproof on this end.

It is apparent from the preceding description of several surgical instruments, given only as examples, that the invention, by providing for the fixation of a connected part, fixed flat or in the form of a flag on the external face of an instrument, allows an X-ray reader to recognize the instrument. In the case of the invention, the identification part is placed at an appropriate place, and it can have a shape which is adapted to the place of fixation.

Because the part is fixed to the exterior of the instrument, it, and thus the identification element, does not have to be as small as possible, so that the identification element could bear information in addition to that which is strictly required for the identification of the instrument, for example, relative to other aspects, notably connected with the use of the instrument.

1. A surgical instruments defined by shape and function and comprising an identification part, for the identification of the instrument, connected on an external face of the instrument, wherein
the identification part contains an identification element identifying the instrument, the identification element including specifically shaped cutouts constituting identification information, and
the identification element is a relatively X-ray opaque material, while the identification part, and the instrument, are made of a relatively X-ray transparent material.

2. The instrument according to claim 1, wherein the identification element has a flat shape.

3. The instrument according to claim 1, wherein the identification element is a body of revolution, and the cutouts are circular.
